(19) United States
(12) Patent Application Publication
(10) Pub. No.: US 2013/0339937 A1
(43) Pub. Date: Dec. 19, 2013

(54) DYNAMIC APPLICATION MANAGEMENT

(71) Applicants: Richard Wayne Meggison, SR., Wales, PA (US); Paul A. Gwaltney, Centreville, VA (US)

(72) Inventors: Richard Wayne Meggison, SR., Wales, PA (US); Paul A. Gwaltney, Centreville, VA (US)

(73) Assignee: AVAYA INC., Basking Ridge, NJ (US)

(21) Appl. No.: 13/523,549

(22) Filed: Jun. 14, 2012

(51) Int. Cl. G06F 9/44

(52) U.S. Cl. 717/168

(57) ABSTRACT

Embodiments disclosed herein provide systems, methods, and software for dynamically managing applications. In particular, automatic application removal or uninstallation from a computing device can occur upon satisfaction of a particular condition or conditions. In one example, a method implemented on a computing device calls for receiving a condition, the occurrence of which indicates when an application installed on the computing device should be uninstalled. An element in an operating system of the computing device is monitored to determine whether the condition is satisfied and, if the condition is satisfied, uninstall the application from the computing device.

### TECHNICAL BACKGROUND

A wide range of applications are available for computing devices configured to download and run those applications. The applications perform various functions for users of the computing devices on which they are installed. The types of applications cover a wide range of functionality, including email, web browsing, games, media viewing, information gathering, or any other type of functionality that can be performed on a computing device.

In a prevalent example, modern smartphones have access to application stores where a user can find applications for download and installation on his or her smartphone device. Hundreds of thousands of applications, sometimes referred to simply as “mobile apps”, are available through the app stores. In addition, such apps can be obtained by way of kiosks and other delivery mechanisms.

Once applications from the store or other source are installed on the smartphone, in addition to running the applications, the user can arrange the applications in a manner allowed by the operating system of the smartphone and uninstall the application should the user have a desire to do so. The user may want to uninstall an application because the user does not use the application anymore, the application no longer functions, the user needs to free up storage space on the smartphone, or for many other reasons.

### OVERVIEW

Embodiments disclosed herein provide systems, methods, and software for dynamically managing applications. In particular, automatic application removal or uninstallation from a computing device can occur upon satisfaction of a particular condition or conditions. In one example, a method implemented on a computing device calls for receiving a condition, the occurrence of which indicates when an application installed on the computing device should be uninstalled. An element in an operating system of the computing device is monitored to determine whether the condition is satisfied and, if the condition is satisfied, uninstall the application from the computing device.

### BRIEF DESCRIPTION OF THE DRAWINGS

FIG. 1 illustrates a computing device.

FIG. 2 illustrates the operation of the computing device.

FIG. 3 illustrates a wireless communication system.

FIG. 4 illustrates the operation of the wireless communication system.

FIG. 5 illustrates a wireless communication device.

FIG. 6 illustrates an example of condition satisfaction.

FIG. 7 illustrates an example of condition satisfaction.

FIG. 8 illustrates a wireless communication device.

FIG. 9 illustrates a wireless communication device.

FIG. 10 illustrates a computing device.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates computing device 101. Computing device 101 includes hardware processing circuitry for executing software instructions and memory for storing those software instructions. Computing device 101 may further include a display, speaker, microphone, buttons, keyboard, network adaptor, wireless communication radio, GPS receiver, accelerometer, or any other hardware-computing element—including combinations thereof. Computing device 101 may be a telephone, personal computer, laptop, e-book reader, mobile Internet appliance, wireless network interface card, media player, game console, or some other computing apparatus—including combinations thereof.

The software stored in the memory and executed by the processing circuitry of computing device 101 includes operating system 102 and applications 103. Operating system 102 includes instructions necessary for computing device 101 to function. Operating system 102 is shown as being broken up into one or more elements 1-N that each performs various operating functions for computing device 101. For example, element 1 may maintain user notifications, such as a phone ringer or received message indicator, and element 2 may control a graphical user interface. Though shown for clarity, the functions of operating system 101 need not be divided into elements.

Operating system 102 further provides a software application platform onto which applications 1-N can be installed. This application platform may provide an application programming interface (API) that applications 1-N use to interact with elements 1-N of operating system 102. For example, if application 1 needs to issue a notification, then application 1 uses the API to access element 1 to issue the notification. When installed, applications 1-N may be stored in the memory of computing device 101, remotely over a communication link, such as in a cloud computing environment, or in some combination thereof.

In operation, a user interacts with computing device 101 through operating system 102. The user may use buttons, touchscreens, switches, voice control, or other actions to interact with the functions of operating system 102. The user may perform one or more of these actions to select an application to run of applications 1-N when the user wants to use that application. Operating system 102 then performs the actions needed to execute the application on computing device 101. For example, the user may indicate application 2, an e-mail application, from a directory of applications installed on computing device 101. One or more of elements 1-N then perform the operations necessary to present the user interface for application 1 and check an email server for new email messages, as instructed by application 1.

Applications 1-N may be preinstalled on computing device 101 by the manufacturer or may be installed at a later time by a user or other entity. Applications 1-N may be downloaded to computing device 101 from an application store, transferred from a personal computer, transferred from some form of media, such as a CD, DVD, or USB drive, or any other method for receiving applications.

Once installed on computing device 101, a user of computing device 101 manages applications 1-N by organizing applications 1-N in an application directory of operating system 102. For example, operating system 102 may provide folders and display screen sections where application icons can be placed. The user is able to place application icons in the various folders and screen sections.

Additionally, the user is able to uninstall applications from computing device 101. The user may desire to uninstall an application because the user no longer uses the application, to free up memory on computing device 101, or any other reason that a user may want to remove an application from a computing device. However, while the user is able to remove applications from computing device 101, a user may not necessarily take action to remove an application even though the application is no longer of use to the user.

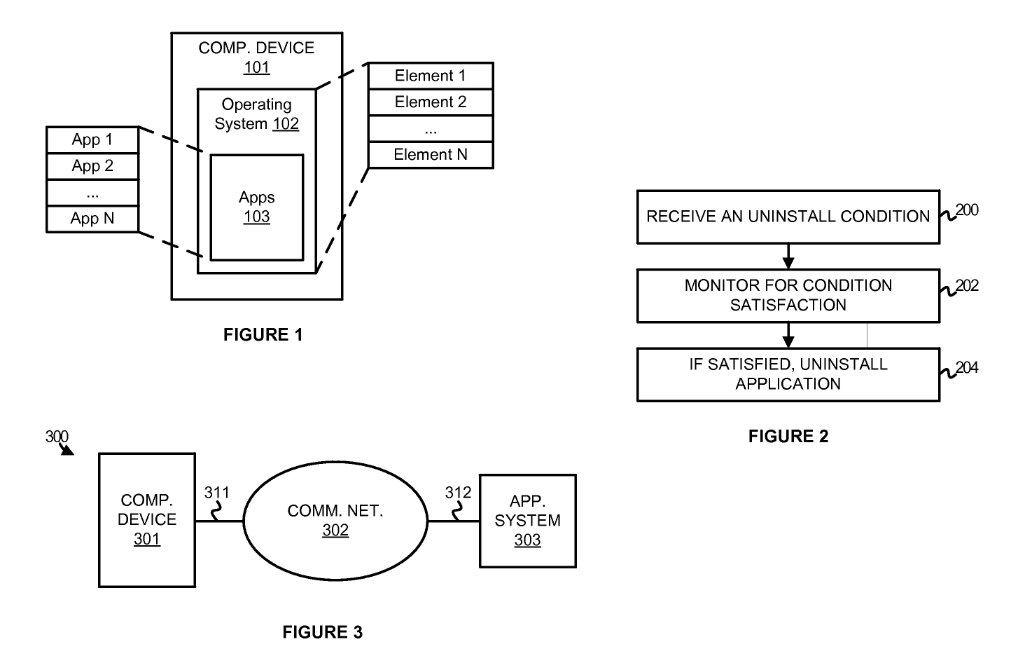

FIG. 2 illustrates the operation of computing device 101 for automatic application removal upon satisfaction of conditions. Computing device 101 receives a condition, the occurrence of which indicates when an application installed on the computing device should be uninstalled (step 200). In this example, the application is application 1 of applications 1-N. The condition may be received from application 1, from a user of computing device 101, from a system remote to computing device 101, or from any other source. For example, when first installed, application 1 may indicate that application 1 should be uninstalled upon satisfaction of a condition. Alternatively, a user of computing device 101 may indicate that the user wants application 1 to be uninstalled upon satisfaction of the condition.

The condition may be any condition that can be checked for satisfaction by computing device 101. Conditions may include a time period that application 1 must operate within, a physical boundary that computing device 101 must stay within or without, a number of uses of application 1, a superseding application being installed on computing device 101, or any other possible condition. For example, a time period may indicate that application 1 should be uninstalled on or after a particular date and/or time or that application 1 should be uninstalled after an amount of time has elapsed from installation of application 1, first use of application 1, last use of application 1, or from any other milestone.

In some embodiments, a designated area of the user interface for operating system 102 can be configured to have certain uninstall conditions. Any application that is placed either automatically or manually by the user into that area inherits the uninstall conditions for the area and those are the conditions received in step 200. The area may be a folder, desktop screen, list, or any other way of segregating applications in a computing device.

Once the condition is received, an element in operating system 102 is monitored to determine whether the condition is satisfied (step 202). The element of elements 1-N that is monitored depends on the condition. For example, if the condition is based on a time period, then an element(s) that controls clock/calendar for operating system 102 will be monitored for satisfaction of the criteria. An element that manages when applications are opened or installed may also be monitored if the time period is an amount of time elapsing from an application event, such as install or opening of application 1. In an additional example, if the condition is based on the location of the computing device, then an element that provides location functionality for operating system 102, such as an element that interacts with a GPS module of wireless device 101, is monitored for the current location of computing device 101.

In some embodiments, multiple conditions may exist. These multiple conditions may be satisfied in various combinations depending on how the multiple conditions are defined. For example, both a time condition and a location condition may be provided for application 1. The uninstallation of application 1 may thereby be triggered only upon satisfaction of both conditions, satisfaction of one condition, satisfaction of one condition before the other condition, satisfaction of one condition within a time period of satisfaction of the other condition, or any other variation of multiple condition satisfaction.

Satisfaction of the condition may be monitored by operating system 102, application 1 itself, another of applications 1-N, or by some other software or hardware component of computing device 101. In one example, at least part of application 1 runs in the background on computing device 101 and monitors for satisfaction of the condition. In another example, element 2 in operating system 102 monitors for satisfaction of the condition. In yet another example, application 2 is an application that monitors for satisfaction of the conditions. Element 2 and application 2 may be further configured to monitor for conditions that indicate that other applications should be uninstalled as well. Whichever component monitors for the condition to be satisfied in step 202 is also the component that must receive the condition in step 200 so that condition monitoring is possible.

In some embodiments, an API for operating system 102 provides the necessary tools for a monitoring component to access elements of operating system 102 to monitor for satisfaction of the condition.

If the condition is satisfied, application 1 is uninstalled from computing device 101 (step 204). Whichever component of computing device 101 is monitoring for satisfaction of the condition indicates that application 1 should be uninstalled. The indication may be made to an element of elements 1-N in operating system 102 that controls the uninstallation of applications on computing device 101. For example, there may exist an API call in operating system 102 that uninstalls application 1. In an alternative example, the monitoring component may have the capability of uninstalling application 1 itself upon determining that the condition is satisfied. Additionally, in situations where operating system 102 does not allow uninstallation of applications without user intervention, the component may direct operating system 102 to notify the user that application 1 should be uninstalled and the user will perform any necessary actions to uninstall application 1.

In some embodiments, the user of computing device 101 may receive notifications indicating when an application has a condition and when an application is going to be uninstalled to provide warning about the conditional uninstall functionality.

Advantageously, the operation described in FIG. 2 allows for applications to be uninstalled from a computing device based on monitoring elements within the computing device. This relieves a user from the responsibility of keeping track of applications that should or need to be uninstalled from computing device 101. Furthermore, the method allows application providers to set conditions under which their application is uninstalled from a user's computing device.

In some embodiments, a user may have multiple devices, such as a smartphone and a tablet, that are able to run the same applications. These applications may be synchronized across the multiple devices. Additionally, if any of the applications synchronized across the multiple devices have conditions for uninstalling the applications, then those conditions may also be synchronized across the devices.

It should be understood that the above method can apply to any type of computing device that is able to install/uninstall applications. Thus, while many of the embodiments below pertain to wireless communication devices, such as smartphones, the method also applies to desktop computers, gaming systems, and other computing devices.

FIG. 3 illustrates communication system 300. Wireless communication system 300 includes computing device 301, communication network 302, and application system 303. Computing device 301 and wireless communication system 302 communicate over communication link 311. Wireless communication network 302 and application system 303 communicate over communication link 312.

In this embodiment, computing device 301 is a device, such as a smartphone, tablet, PC, or other device, that is capable of downloading and installing applications from application system 303. The applications available for download from application system may be presented to a user through a web based interface on computing device 101, through an application already installed on computing device 301, through a web interface on another device, such as a PC if computing device 301 is a smartphone or the like, or any other method through which a user may obtain applications. Furthermore, the interfaces that present the applications to a user may be part of an application store where paid and non-paid applications are available for download. Computing device 301 may be able to install applications from other sources as well.

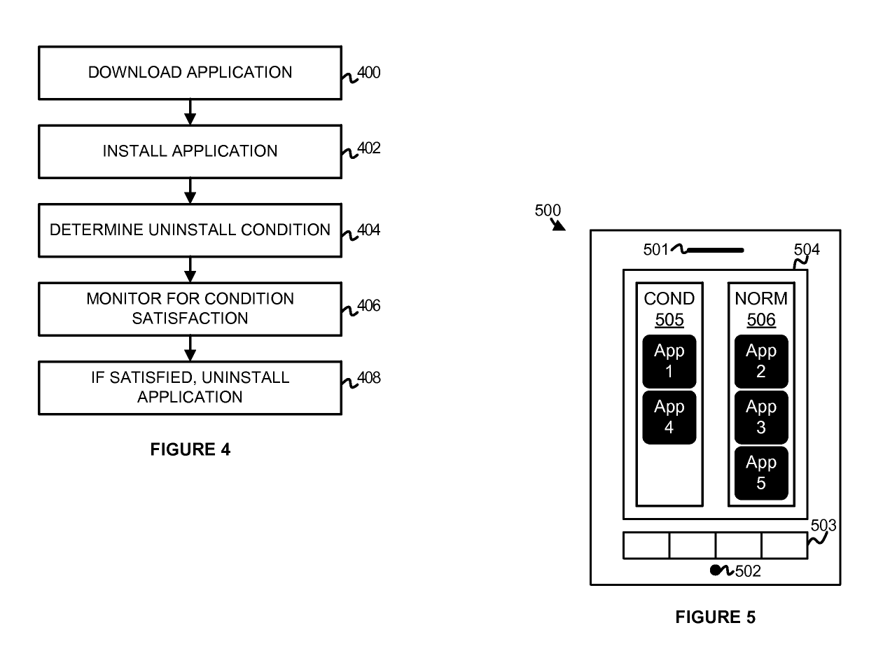

FIG. 4 illustrates the operation of communication system 300 for automatic application removal upon satisfaction of conditions. Once a user selects an application for download from application system 303, computing device 301 downloads the selected application from application system 303 over communication network 302 (step 400). Upon completion of the download, the application is installed onto computing device 301 (step 402).

At a point in time after the application is installed, uninstall conditions are determined for the application (step 404). In this example, the application includes the uninstall condition and includes a monitor component that monitors for when the condition is met. Therefore, at least the monitor component of the application executes on computing device 301 continually enough to monitor the functions of the operating system for computing device 301 to determine whether the condition is satisfied (step 406). Upon recognizing that the condition is satisfied, the application instructs the operating system of computing device 301 to uninstall the application from wireless device 301 (step 408).

In a more specific example of the above embodiment, a user downloads an application for a sporting event, such as the Olympics, to computing device 301 from application system 303. Since the Olympics last for a finite period of time, the information provided by the application, such as event maps, event schedules, athlete information, event related media, etc., may be of no use to the user after the Olympics end even though the information itself may still accessible by the user via the application. Thus, the application includes a condition, or has a condition provided by the user, that indicates the application should be uninstalled when the Olympics are over. The condition could indicate a specific date and/or time when the application should be uninstalled, a time period from when the application is last used or installed, or any other condition relating to the finality of the Olympics. In accordance with the condition, the user is able to run the application to access the information provided during the Olympics and the application is uninstalled from computing device 301 when the Olympics are over. This aids the user by uninstalling an application that the user would have otherwise needed to uninstall manually when the Olympics ended.

Referring back to FIG. 3, computing device 301 comprises a hardware communication interface for communicating with communication network 302. The communication interface may comprise an Ethernet network circuitry, or some other wireline networking circuitry, and/or radio Frequency (RF) communication circuitry and an antenna for wireless communications. RF communication circuitry typically includes an amplifier, filter, modulator, and signal processing circuitry. Computing device 301 may also include a user interface, memory device, software, processing circuitry, or some other communication components. Computing device 301 may be a telephone, computer, e-book, mobile Internet appliance, wireless network interface card, media player, game console, or some other wireless communication apparatus—including combinations thereof.

Communication network 302 comprises network elements that provide communications services to computing device 301. Communication network 302 may comprise switches, wireless access nodes, Internet routers, network gateways, application servers, computer systems, communication links, or some other type of communication equipment—including combinations thereof.

Application system 303 comprises a computer system and communication interface. Application system 303 may also include other components such a router, server, data storage system, and power supply. Application system 303 may reside in a single device or may be distributed across multiple devices. Application system 303 could be a web server, data server, or any other type of system capable of storing and distributing software applications.

Communication links 311 and 312 use metal, glass, air, space, or some other material as the transport media. Communication links 311 and 312 could use various communication protocols, such as Time Division Multiplex (TDM), Internet Protocol (IP), Ethernet, communication signaling, CDMA, EVDO, WIMAX, GSM, LTE, WIFI, HSPA, or some other communication format—including combinations thereof. Communication links 311 and 312 could be direct links or may include intermediate networks, systems, or devices.

FIG. 5 illustrates wireless communication device 500. Wireless communication device 500 includes speaker 501, microphone 502, buttons 503, and display 504. Wireless communication device 500 may have alternative configurations and have more or fewer elements than those shown in FIG. 5. Display 504 is displaying conditional folder 505 and normal folder 506 in a graphical user interface for an operating system of wireless communication device 500. It should be understood that folders 505 and 506 are merely shown for exemplary purposes and do not necessarily depict how folders are displayed on wireless device 500.

In operation, a user of wireless device 500 creates a conditional folder 505. When creating conditional folder 505 the user specifies a condition under which the applications within conditional folder 505 should be uninstalled. Therefore, when applications 1 and 4 are placed into conditional folder 505, applications 1 and 4 are subject to uninstallation if the condition for conditional folder 505 is satisfied. In contrast, applications 2, 3, and 5, which remain in a normal unconditional folder 506, are not subject to the condition. An element of the operating system of wireless device 500 monitors to see whether the condition of conditional folder 505 is satisfied for either of applications 1 and 4. If the condition is satisfied, then the operating system element uninstalls the application to which the condition applied.

In an example, a user may want a folder that deletes applications at the end of a vacation so that the user can install applications relating to the vacation location and not have to worry about uninstalling them later. The user creates conditional folder 505 and sets the condition as being a date when the user's vacation has ended. Accordingly, applications 1 and 4 placed in conditional folder 505 are uninstalled when the date is reached.

In another example, conditional folder 505 may be synchronized across multiple wireless devices. Therefore, if a user has multiple computing devices that are capable of running applications 1-5, then the contents and parameters of conditional folder 505 may be synchronized across the multiple devices as well.

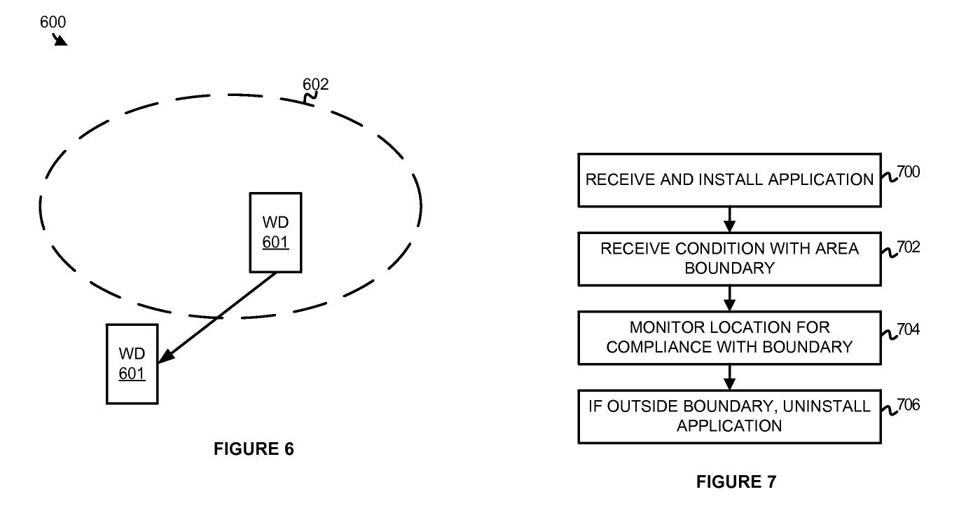

FIG. 6 illustrates a physical location 600 where a wireless device may be located. The physical location includes conditional area 602 and wireless communication device 601. Physical location 600 may be any location where a wireless communication device may be located.

FIG. 7 illustrates the operation of wireless communication device 601 as it moves throughout physical location 600. In operation, a user of wireless device 601 directs wireless device 601 to receive and install an application (step 700). A monitoring software component of wireless device 601 receives a condition for uninstalling the application that provides for the application to be uninstalled upon wireless device 601 leaving conditional area 602 (step 702). While shown as an oval area, conditional area 602 may take any shape and be any size in two or three dimensions. Moreover, conditional area 602 could be defined in any way, such as city, state, geographic coordinates, etc. The monitoring component monitors information from an element in the operating system of wireless device 601 that determines the location of wireless device 601 (step 704). If the monitoring component receives information from the location element indicating that wireless device 601 has moved outside of conditional area 602, as indicated by the arrow in FIG. 6, then the monitoring component instructs the operating system of wireless device 601 to uninstall the application (step 706).

In an example of the above method, the user of wireless device 601 is visiting an amusement park. Upon entry into the park the user sees a sign that directs the user to download an application with park related information. After downloading and installing the application, the user sets a condition under which the application should be uninstalled. Specifically, the user wants the application to uninstall once the user leaves the amusement park. Therefore, conditional area 602 corresponds to the area covered by the amusement park. The user is able to use the application at his or her pleasure while visiting the park. Then, when the user decides to leave the park, the application is uninstalled when wireless device 601 exits conditional area 602 and the user does not have to worry about uninstalling the application manually.

In another example, conditional area 602 may cause an application to uninstall when wireless device 601 enters conditional area 602. In this example, the user of wireless device 601 is attending a sporting event at a stadium. The user downloads and installs an application that provides the user with information and media related to the event, such as stats, analysis, and video clips. However, the league that puts on the event does not want the application to be used when inside the stadium. The league may not want the application to be used within the stadium because within the stadium there are other services that provide similar information, which the league would prefer be used instead, or for any other reason. Therefore, the league has the provider of the application include a condition within the application that provides for the application to be uninstalled when wireless device 601 enters the stadium, which is conditional area 602. Accordingly, while the user is outside the stadium, the user is able to use the application. Then, when the user brings wireless device 601 into the stadium (conditional area 602), the application is uninstalled from wireless device 601.

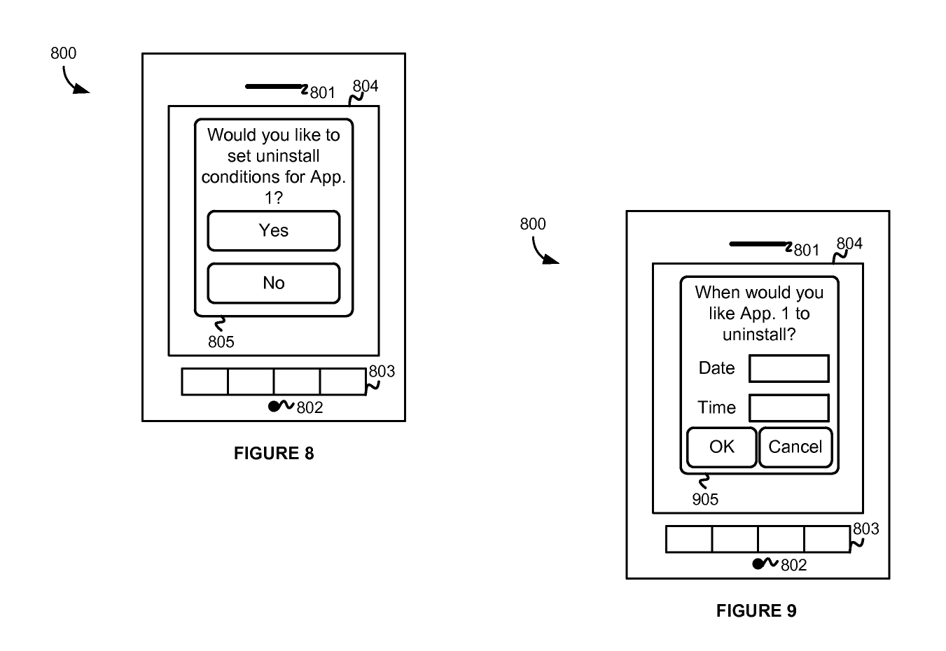

FIG. 8 illustrates wireless communication device 800. Wireless communication device 800 includes speaker 801, microphone 802, buttons 803, and display 804. Wireless communication device 800 may have alternative configurations and have more or fewer elements than those shown in FIG. 8. Display 804 is displaying option block 805, which asks a user if the user would like to set uninstall conditions for application 1. It should be understood that option block 805 is merely shown for exemplary purposes and does not necessarily depict how the option to set conditions is presented on wireless device 800.

In operation, option block 805 may be displayed when an application 1 is installed on wireless device 800 or at some other time, such as a user selecting a setting for application 1. Upon seeing the option block, the user can select ‘yes’ or ‘no’ to indicate whether the user would like to set a condition for application 1 to be uninstalled. If the user selects ‘no,’ then application 1 is treated normally and will not be uninstalled upon satisfaction of a condition. The user will therefore have to manually direct wireless device 800 to uninstall application 1 if the user so desires.

FIG. 9 illustrates wireless communication device 800 in an embodiment where the use selected ‘yes’ in option block 805 of FIG. 8. After selecting ‘yes,’ display 804 displays condition entry block 905. It should be understood that condition entry block 905 is merely shown for exemplary purposes and does not necessarily depict how conditional entry fields are presented on wireless device 800.

In this example, the condition that is allowed to be set is a time constraint. Thus, the user is able to enter a date in the date field and a time in the time field in order to set the condition for uninstalling application 1 as a date/time. Accordingly, after pressing ‘OK,’ the operation of wireless device 800 will be monitored for satisfaction of the date/time condition.

Option block 805 and condition entry block 905 may be provided by the component of wireless device 800 that monitors for satisfaction of the condition. Likewise, the condition information entered by the user in response to blocks 805 and 905 may be provided to that component. Thus, an element of the operating system for wireless device 801, application 1 itself, another application on wireless device 800, or some other monitoring component will display blocks 805 and 905 to receive condition information for application 1.

In some embodiments additional displays may exist that, for example, will allow the user to select a type of condition instead of going directly to the time based condition entry block 905. Specifically, a conditional type block may be displayed that allows a user to first select the type of condition, or types of conditions, that the user desires. Thus, the user may be able to select location based conditions, time based conditions, use base conditions, or any other type of condition that a computing device can monitor.

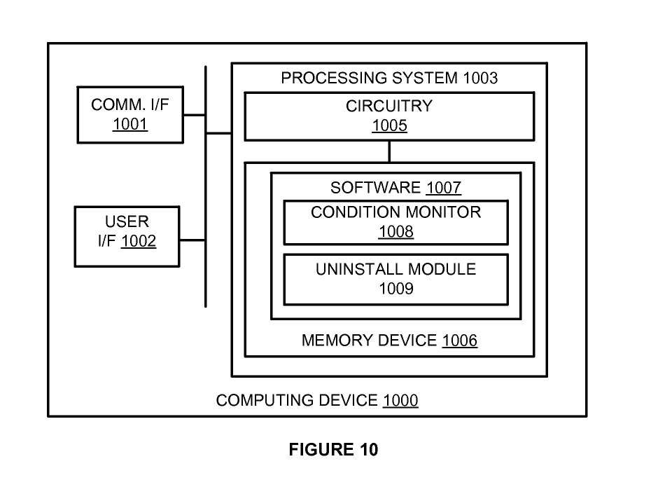

FIG. 10 illustrates computing device 1000. Computing device 1000 is an example of computing device 101 or wireless devices 301, 500, and 800, although devices 101, 301, 500, and 800 could use alternative configurations. Computing device 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007. Computing device 1000 may include other well-known components such as a battery and enclosure that are not shown for clarity. Computing device 1000 may be a telephone, computer, e-book reader, mobile Internet appliance, media player, game console, wireless network interface card, or some other computing device—including combinations thereof.

Communication interface 1001 comprises components that communicate over communication links, such as network cards, ports, RF transceivers, processing circuitry and software, or some other communication devices. Communication interface 1001 may be configured to communicate over metallic, wireless, or optical links. Communication interface 1001 may be configured to use TDM, IP, Ethernet, optical networking, wireless protocols, communication signaling, or some other communication format—including combinations thereof.

User interface 1002 comprises components that interact with a user to receive user inputs and to present media and/or information. User interface 1002 may include a speaker, microphone, buttons, lights, display screen, touch screen, touch pad, scroll wheel, communication port, or some other user input/output apparatus—including combinations thereof. User interface 1002 may omitted in some examples.

Processing circuitry 1005 comprises microprocessor and other circuitry that retrieves and executes operating software 1007 from memory device 1006. Memory device 1006 comprises a non-transitory storage medium, such as a disk drive, flash drive, data storage circuitry, or some other memory apparatus. Processing circuitry 1005 is typically mounted on a circuit board that may also hold memory device 1006 and portions of communication interface 1001 and user interface 1002. Operating software 1007 comprises computer programs, firmware, or some other form of machine-readable processing instructions. Operating software 1007 includes condition monitoring module 1008 and uninstallation module 1009. Operating software 1007 may further include an operating system, utilities, drivers, network interfaces, applications, or some other type of software. When executed by processing circuitry 1005, operating software 1007 directs processing system 1003 to operate computing device 1000 as described herein.

In particular, condition monitoring module directs processing system 1003 to receive a condition, the occurrence of which indicates when an application installed on computing device 1000 should be uninstalled and monitor an element in an operating system of computing device 1000 to determine whether the condition is satisfied. If the condition is satisfied, uninstallation module 1009 directs processing system 1003 to uninstall the application from the computing device.

As described above with respect to FIG. 1, condition monitoring module 1008 may be part of the operating system of computing device 1000, the application installed on computing device 1000, a different application on computing device 1000, or some other independent software component. Though shown separately, uninstallation module 1009 may be incorporated into condition monitoring module 1008. Additionally, operating software 1007 includes the elements that condition monitoring module 1008 monitors for satisfaction of the condition.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A non-transitory computer readable medium having instructions stored thereon for operating a computing device, wherein the instructions, when executed by the computing device, direct the computing device to:
receive a condition, the occurrence of which indicates when an application installed on the computing device should be uninstalled;
monitor an element in an operating system of the computing device to determine whether the condition is satisfied; and
if the condition is satisfied, uninstall the application from the computing device.

2. The non-transitory computer readable medium of claim 1, wherein the instructions that direct the computing device to monitor the element in the operating system of the computing device comprise a second element of the operating system of the computing device.

3. The non-transitory computer readable medium of claim 1, wherein the instructions that direct the computing device to monitor the element in the operating system of the computing device comprise a second application executing on the computing device.

4. The non-transitory computer readable medium of claim 1, wherein the instructions that direct the computing device to monitor the element in the operating system of the computing device are part of the application.

5. The non-transitory computer readable medium of claim 1, wherein the instructions further direct the computing device to:
download the application; and
install the application on the computing device.

6. The non-transitory computer readable medium of claim 1, wherein the instructions that direct the computing device to receive the condition, receive the condition by directing the computing device to:
determine whether the application is placed in a designated area of a graphical user interface for the operating system; and
if the application is placed in the designated area, receive the condition from the operating system, wherein the condition is associated with the designated area.

7. The non-transitory computer readable medium of claim 1, wherein the condition is received from the application.

8. The non-transitory computer readable medium of claim 1, wherein the condition is received from a user of the computing device.

9. The non-transitory computer readable medium of claim 1, wherein the condition comprises a physical area where the computing device is located and wherein the condition is satisfied if the computing device moves outside of the physical area.

10. The non-transitory computer readable medium of claim 1, wherein the condition comprises a period of time and wherein the condition is satisfied when the application is still installed on the computing device outside of the period of time.

11. A method of operating a computing device, comprising:
receiving a condition, the occurrence of which indicates when an application installed on the computing device should be uninstalled;
monitoring an element in an operating system of the computing device to determine whether the condition is satisfied; and
if the condition is satisfied, uninstalling the application from the computing device.

12. The method of claim 11, wherein monitoring the element in the operating system of the computing device is performed by a second element of the operating system of the computing device.

13. The method of claim 11, wherein monitoring the element in the operating system of the computing device is performed by a second application executing on the computing device.

14. The method of claim 11, wherein monitoring the element in the operating system of the computing device is performed by part of the application.

15. The method of claim 11, further comprising:
downloading the application; and
installing the application on the computing device.

16. The method of claim 11, wherein receiving the condition comprises:
determining whether the application is placed in a designated area of a graphical user interface for the operating system; and
if the application is placed in the designated area, receiving the condition from the operating system, wherein the condition is associated with the designated area.

17. The method of claim 11, wherein the condition is received from the application.

18. The method of claim 11, wherein the condition is received from a user of the computing device.

19. The method of claim 11, wherein the condition comprises a physical area where the computing device is located and wherein the condition is satisfied if the computing device moves outside of the physical area.

20. The method of claim 11, wherein the condition comprises a period of time and wherein the condition is satisfied when the application is still installed on the computing device outside of the period of time.
